(19) United States
(12) Patent Application Publication
(10) Pub. No.: US 2007/0224347 A1
(43) Pub. Date: Sep. 27, 2007

(54) Liquid coating apparatus and method thereof

(75) Inventors: Jin Sung Lee, Seoul (KR); Tae Gyu Kim, Hwaseong-si (KR); June Mo Koo, Yongin-si (KR); Chang Hoon Jung, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/525,026

(22) Filed: Sep. 22, 2006

(30) Foreign Application Priority Data
Mar. 22, 2006 (KR) 10-2006-0026057

(51) Int. Cl. B05C 11/02; B05B 3/00; B05D 7/00; B05D 3/12

(52) U.S. Cl. 427/240; 118/323; 118/52; 427/427.3; 118/320

(57) ABSTRACT

A liquid coating apparatus and method for spraying a liquid on a wafer. The liquid coating apparatus may include a nozzle unit spraying the liquid on the wafer and moving relative to the wafer and a laminar flow forming unit forming a forced air flow around the nozzle unit. Though a wake may be formed around the nozzle unit by a movement of the nozzle unit, the laminar forming unit may reduce and/or minimize an influence of the wake.

### PRIORITY STATEMENT

This application claims the benefit of priority to Korean Patent Application No. 10-2006-0026057, filed on Mar. 22, 2006, in the Korean Intellectual Property Office, the entire contents of which is incorporated herein by reference.

### BACKGROUND

1. Field

Example embodiments relate to a liquid coating apparatus and method of spraying liquid on a target object. More particularly, example embodiments relate to a liquid coating apparatus and liquid coating method for evenly spraying one or more micro droplets on a wafer.

2. Description of Related Art

Conventionally, a spin coating method has been utilized for coating a liquid photoresist on a wafer. According to the conventional spin coating method, an amount of the liquid photoresist may be dropped above a rotating wafer and a centrifugal force may cause the liquid photoresist to be spread and coated on the wafer. In the conventional spin coating method, a large amount of the liquid photoresist is dispersed off the wafer and thus, only a small amount of the liquid photoresist dropped on the wafer remains on the wafer. Accordingly, a large amount of the liquid photoresist may be wasted in a conventional spin coating method. Further, the dispersed liquid photoresist may contaminate adjacent equipment.

In order to solve the above mentioned problem, a conventional method of spraying a liquid photoresist on a wafer has been used. In the conventional spray coating method, the amount of liquid photoresist wasted may be reduced because not as much liquid photoresist is dispersed off of the wafer. However, in a conventional spray coating method using a conventional spray coating apparatus, a wake may occur around a spray nozzle during the spray coating process because of a downflow descending from a top surface of a substrate and nozzle transferring. Due to an influence of the wake and the downflow, the uniformity of a thickness of a liquid layer coated on the substrate may be reduced. Furthermore, liquid photoresist not coated on the wafer may contaminate the adjacent equipment.

### SUMMARY

Example embodiments provide a liquid coating method capable of maintaining a laminar flow around a nozzle and decreasing the strength of a wake and an apparatus using the method.

Example embodiments also provide a liquid coating method in which a spraying coating may be stably accomplished by reducing and/or minimizing an influence of an air flow and a contamination problem caused by the dispersal of a liquid droplet and an apparatus using the method.

An example embodiment provides a liquid coating apparatus for spraying a specific liquid on a target object. The liquid coating apparatus may include a nozzle member and a laminar flow forming member.

According to an example embodiment, if a specific liquid, e.g. a liquid photoresist, is coated by a spray coating, an amount of liquid dispersed by the centrifugal force may be reduced and only a proper amount of the specific liquid may be used and/or required.

According to an example embodiment, a laminar flow forming unit may be provided to reduce and/or prevent a wake from forming around the nozzle unit. The laminar flow forming unit may promote a forced air flow to form a laminar flow around the nozzle unit. The forced air flow may be promoted by either suction or blowing of air. In this example embodiment, by forming at least one of a suction hole or a blowing hole around the nozzle unit, a flow separation may be reduced and/or prevented. The suction hole may be formed in a radial shape to reduce and/or prevent the flow separation in a lower portion of the nozzle unit, and the blow hole may reduce and/or prevent the flow separation from occurring in the lower portion of the nozzle unit.

According to an example embodiment, the laminar flow forming unit may be capable of forming the laminar flow in spite of a wake and thus, the spray coating may stably accomplished.

An example embodiment provides a liquid coating apparatus of spraying a specific liquid on a target object. The liquid coating apparatus may include a nozzle member for spraying a liquid and a laminar flow forming member forming a laminar flow using air suction. The nozzle member may include a liquid supply source which supplies the liquid, a supply pump which supplies the liquid with a desired and/or predetermined pressure from the liquid supply source and a spray nozzle which sprays the liquid supplied from the supply pump, while the spray nozzle moves above a target. The laminar flow forming member may include a cover which may be provided around the spray nozzle and have one or more air holes, and a suction pump which may create a relatively low pressure to inhale external air between the cover and the spray nozzle, and an air hole corresponding to a suction hole may be provided in the cover. The cover may be provided around the nozzle to form a double-wall structure. The one or more air holes may be angled and provided close to a tangential line of a surface of the cover to cause air blown from the air hole to flow smoothly along a surface of the cover.

### BRIEF DESCRIPTION OF THE DRAWINGS

The above and/or other aspects and advantages will become apparent and more readily appreciated from the following detailed description of example embodiments taken in conjunction with the accompanying drawings of which:

FIG. 1 is a cross-sectional view illustrating a liquid coating apparatus according to an example embodiment;

FIG. 2 is a cross-sectional view illustrating a nozzle unit and a laminar flow forming unit of a liquid coating apparatus according to an example embodiment;

FIG. 3 is a side view illustrating the laminar flow forming unit of FIG. 2;

FIG. 4A is a top view illustrating an example result of spraying and use of a laminar flow forming unit according to an example embodiment;

FIG. 4B is a top view illustrating an example result of spraying according to a conventional method and conventional device;

FIG. 5A is a side view illustrating an example result of spraying and use of a laminar flow forming unit according to an example embodiment;

FIG. 5B is a side view illustrating an example result of spraying according to a conventional method and conventional device;

FIGS. 6A and 6B are cross-sectional views illustrating a nozzle member and a laminar flow forming unit according to various example embodiments;

FIGS. 7A and 7B are side views illustrating a laminar flow forming unit according to various example embodiments;

FIG. 8 is a configuration diagram illustrating a liquid coating apparatus according to an example embodiment;

FIGS. 9A, 9B, and 9C are side views illustrating a laminar flow forming unit according to various example embodiments;

FIG. 10 is a cross-sectional view illustrating a nozzle unit and a laminar flow forming unit according to an example embodiment;

FIG. 11 is a side view illustrating the nozzle unit and the laminar flow forming unit of FIG. 10; and

FIG. 12 is a cross-sectional view illustrating an example result of spraying along with use of a laminar flow forming unit according to an example embodiment.

### DETAILED DESCRIPTION OF EXAMPLE EMBODIMENTS

Example embodiments are described more fully hereinafter with reference to the accompanying drawings. Embodiments may, however, be in many different forms and should not be construed as limited to the example embodiments set forth herein. Rather, these example embodiments are provided so that this disclosure will be thorough and complete, and will fully convey the scope to those skilled in the art. In the drawings, the size and relative sizes of components may be exaggerated for clarity.

It will be understood that when a component is referred to as being “on,” “connected to” or “coupled to” another component, it can be directly on, connected to or coupled to the other component or intervening components may be present. In contrast, when a component is referred to as being “directly on,” “directly connected to” or “directly coupled to” another component, there are no intervening components present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one component or feature's relationship to another component(s) or feature(s) as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference will now be made to example embodiments, which are illustrated in the accompanying drawings, wherein like reference numerals refer to the like components throughout.

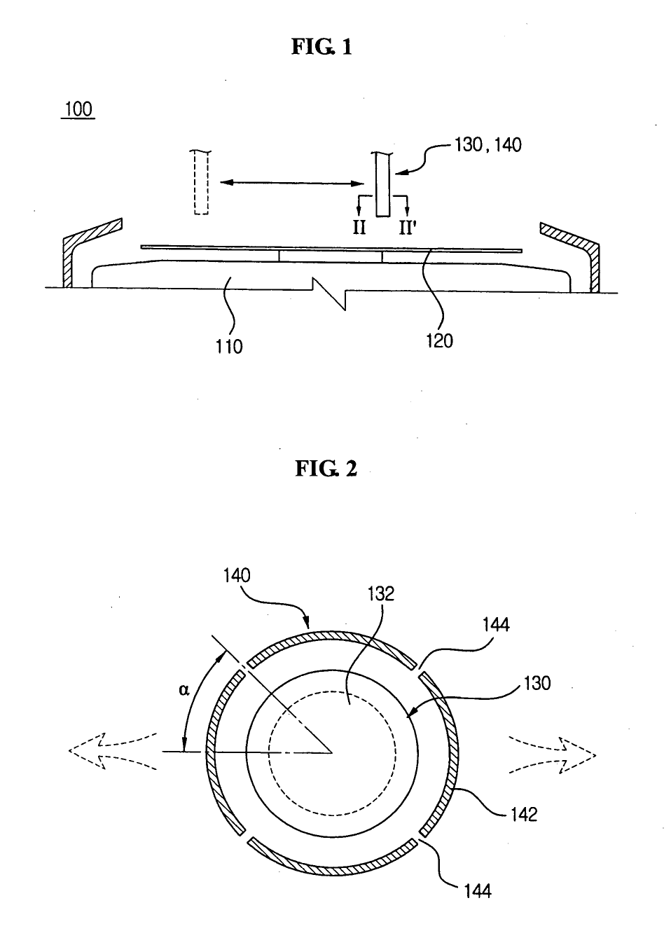

FIG. 1 is a cross-sectional view illustrating a liquid coating apparatus according to an example embodiment.

Referring to FIG. 1, a liquid coating apparatus 100 may include a support 110 configured to support a wafer 120 arranged on the support 110. The support 110 may be arranged in the center of the liquid coating apparatus 100. The liquid coating apparatus 100 may also include a nozzle unit 130 and a laminar flow forming unit 140. The nozzle unit 130 may be arranged above the support 110 and may be configured to move relative to the support 110 and/or a wafer 120 arranged on the support 110. The laminar flow forming unit 140 may be connected to and/or arranged around the nozzle unit 130 and may be configured to form a forced air flow around the nozzle unit 130.

The nozzle unit 130 may move above a wafer 120 along a desired and/or predetermined route, and the laminar flow forming unit 140 may formed in and/or around an exterior wall of the nozzle unit 130 to intake air. At least in part because the laminar flow forming unit 140 intakes the air and the nozzle unit 130 is able to move above the wafer 120 while forming a laminar flow without a wake, a flow separation of air around the nozzle unit 130 may be reduced and/or prevented.

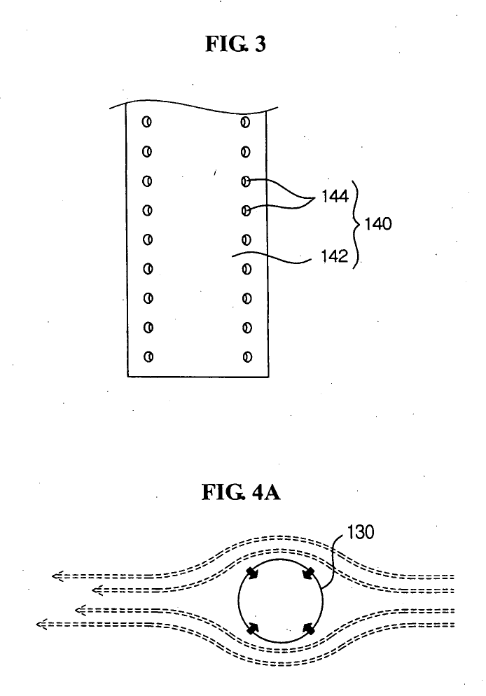

FIG. 2 is a cross-sectional view illustrating a nozzle unit and a laminar flow forming unit according to an example embodiment, which may be used in the liquid coating apparatus 100 of FIG. 1, and FIG. 3 is a side view illustrating the laminar flow forming unit of FIG. 2.

Referring to FIGS. 2 and 3, a nozzle unit 130 may include a nozzle 132 to spray a liquid. For example, the nozzle 132 may be able to spray a liquid, e.g. a liquid photoresist and the like, in the form of one or more micro droplets and may be continuously supplied with the liquid through a supply route in the center of the nozzle 132. A laminar flow forming unit 140 may be provided around the nozzle unit 130. The laminar flow forming unit 140 may include a cover 142 which covers the nozzle 132. The cover 142 may be spaced apart from the nozzle 132 by a desired and/or predetermined distance to form a double-wall structure as shown in FIG. 2.

A plurality of air holes 144 may be provided in the cover 142. The plurality of air holes 144 may be arranged in four rows around the nozzle 132, for example. As illustrated in FIGS. 2 and 3, the plurality of air holes 144 may be formed on a basis of the nozzle 132 and may be vertically and horizontally symmetrical with each other. As shown by the dashed arrows in FIG. 2, the nozzle 132 may be configured to move horizontally. According to an example embodiment, the air holes 144 may be distributed at an angle relative to the moving direction of the nozzle 132 within a range of about 45 degrees to about 135 degrees. More specifically, the air holes 144 may be distributed at an angle relative to the moving direction of the nozzle 132 within a range of about 60 degrees to about 75 degrees.

Again referring to FIG. 1, a slight downflow may be formed above the wafer 120 in the liquid coating apparatus 100. Generally, approximately 0.4 m/s of the downflow may be formed on a top surface of the wafer 120, and the downflow on the wafer 120 may be radially spread out on the wafer 120.

The support 110 may rotate at a velocity of approximately 20˜30 rpm. It is worth noting that in a conventional spin coating method and apparatus, the rotation support is required to rotate at a velocity of approximately 1,000˜5,000 rpm to evenly coat a liquid. Accordingly, the support 110 of liquid coating apparatuses according to example embodiments may rotate at a significantly lower velocity. A coater ball may be provided around the support 110 to reduce and/or prevent the liquid from outwardly dispersing. Further, because the velocity of rotation of the support 110 in example embodiments is relatively slow, the coater ball may not be utilized as much as in conventional spin coating methods and apparatuses.

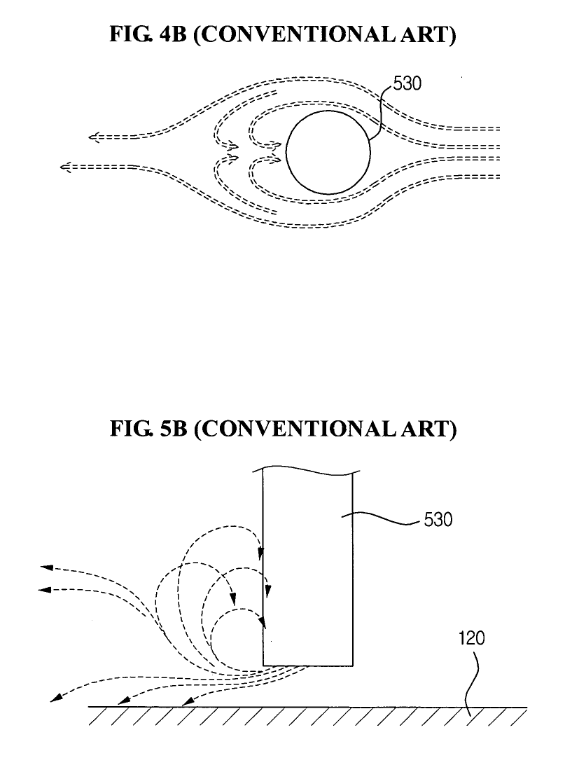

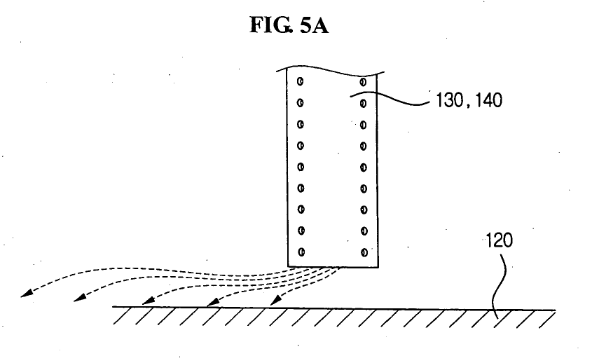

FIG. 4A is a top view illustrating an example result of a spraying method according to an example embodiment using a laminar flow forming unit, whereas FIG. 4B is a result of a conventional spraying method. Similarly, FIG. 5A is a side view illustrating an example result of a spraying method according to an example embodiment using a laminar flow forming unit, whereas FIG. 5B is a side view illustrating a conventional spraying method.

The double dashed lines in FIGS. 4A and 4B illustrate a flow of air, and the single dashed lines in FIGS. 5A and 5B illustrate traces of sprayed micro droplets.

In a conventional spraying method and/or apparatus in which a laminar flow forming unit 140 is not present as shown in FIGS. 4B and 5B, as the conventional nozzle unit 530 moves, a wake may occur behind a back surface of the nozzle unit 530. As illustrated, the wake may spin around behind the nozzle unit 530 and/or collide with the back surface of the nozzle unit 530. Due to the wake, a micro droplet sprayed from the nozzle unit 530 may be dispersed along a route without coating a top surface of a wafer. In other words, a portion of the micro droplet sprayed from the nozzle unit 530 may spin around behind the nozzle unit 530 because of the wake and may stick to the back surface of the nozzle unit 530. As an amount of micro droplets sticking to the back surface of the nozzle unit 530 increases, a liquid may become formed on a surface of the nozzle unit 530, and the formed liquid may drop on the top surface of the wafer, and this liquid may prevent a wafer from being evenly coated.

Conversely, in example embodiments, even if the nozzle unit 130 moves within the downflow, if a laminar flow forming unit 140 is operated, a wake may be reduced and/or prevented from occurring behind a back surface of the nozzle unit 130 as shown in FIGS. 4A and 5A. If a wake does occur, an area influenced by the wake may be reduced and/or minimized. According to example embodiments, a laminar flow may be formed around the nozzle unit 130, and a flow separation may be reduced and/or prevented from occurring.

According to an example embodiment as shown in FIGS. 4A and 5A, the micro droplets sprayed from the nozzle 132 may be at least partially coated on the wafer 120, and the rest of the micro droplets with the wake may ascend and float in the air, but do not reach and/or stick to the back surface of the nozzle unit 130. Accordingly, the micro droplet may be directly sprayed on the wafer 120 and liquid generally does not form on the nozzle unit 130 even if a plurality of wafers 120 is repeatedly processed. Because the liquid generally does not form on the nozzle unit 130, the nozzle 132 may remain clean and thus, the liquid coating operation may be executed for relatively long periods of time.

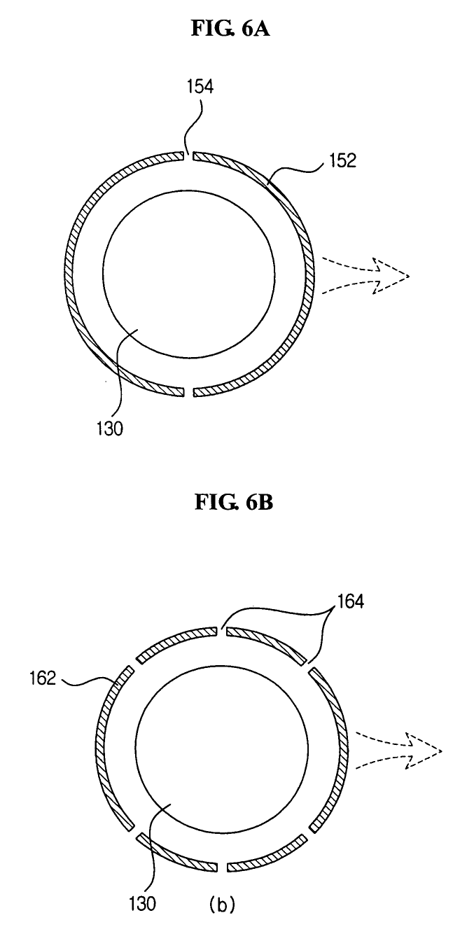

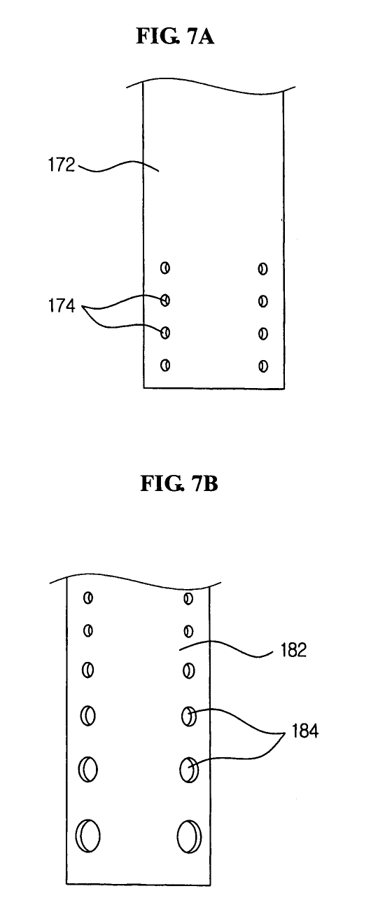

FIGS. 6A and 6B are cross-sectional views illustrating a nozzle member and a laminar flow forming member according to another example embodiment, and FIGS. 7A and 7B are side views illustrating a laminar flow forming according to still another example embodiment.

Referring to FIGS. 6A and 6B, a cover 152 may cover a nozzle unit 130. The cover 152 may be spaced apart from an external wall of the nozzle unit 130 by a desired and/or predetermined distance, and a plurality of the air holes may be formed in the cover 152. The number and location of the air holes may be variously arranged, as illustrated in FIGS. 6A and 6B. For example, the air holes 154 are arranged in two rows in FIG. 6A, whereas the air holes 164 are arranged six rows in FIG. 6B.

Referring to FIG. 6A, the nozzle unit 130 may move in the direction of the arrow and the air holes 154 may be provided at angles of approximately 90 degrees relative to the moving direction of the nozzle unit 130 indicated by the arrow. A flow separation around the nozzle unit 130 may be reduced and/or prevented from occurring even if the air hole 154 is provided in the most exterior portion of the nozzle unit 130.

Referring to FIG. 6B, the nozzle unit 130 may move in the direction of the arrow and the air holes 164 may be provided in angles of approximately 60, 90 and 120 degrees relative to the moving direction of the nozzle unit 130 indicated by the arrow. The air holes 164 in the cover 162 may be used to help create air suction. A space for air flow may be provided between the cover 162 and the nozzle unit 130, and all of the air holes 164 may perform air suction. The air holes 164 may perform air suction simultaneously. A flow separation around the nozzle unit 130 may occur from various angles. However, the flow separation may be effectively reduced and/or prevented by forming a suction force from various points on the cover 162, e.g., the airholes.

As illustrated in the example embodiments shown in FIGS. 7A and 7B, air holes 174 and 184 in the covers 172 and 182 may be arranged around and/or cover the nozzle unit 130 and may have various characteristics. For example, the air holes 174 and 184 of the covers 172 and 182 may be formed in various sizes and/or a length of a row of the air holes 174 and 184 may vary. Further, as illustrated in FIGS. 7A and 7B, the air holes 174 may be provided at a desired and/or predetermined height. Moreover, a size of the air holes 184 may be increase or decrease along a row in a lengthwise direction. Still further, each air hole in a row may be separated from each other by varying distances.

For example, referring to FIG. 7A, the air holes 174 may be provided in a lower portion of the cover 172. Further, the air holes 174 may not be provided along the entire length of the nozzle unit 130 and/or cover 172, instead the air holes 174 may only be provided along a portion of the length of the nozzle unit 130 and/or the cover 172.

Referring to FIG. 7B, air holes 184 may be provided along an entire length of a cover 182. The size of the air holes 184 may not regular. For example, as a location of the air holes 184 become higher, the size of the air holes 184 may become smaller. Conversely, even though it is not illustrated in FIGS. 7A and 7B, the size of the air holes may become larger as the location of the air holes 184 become higher.

Though the example air holes shown in FIGS. 6A, 6B, 7A and 7B are circular, air holes may be formed in various shapes. For example the air holes may have an oval shape, a slit shape, etc. Also, as previously described, the air holes 174 and 184 may be formed in the same and/or different sizes.

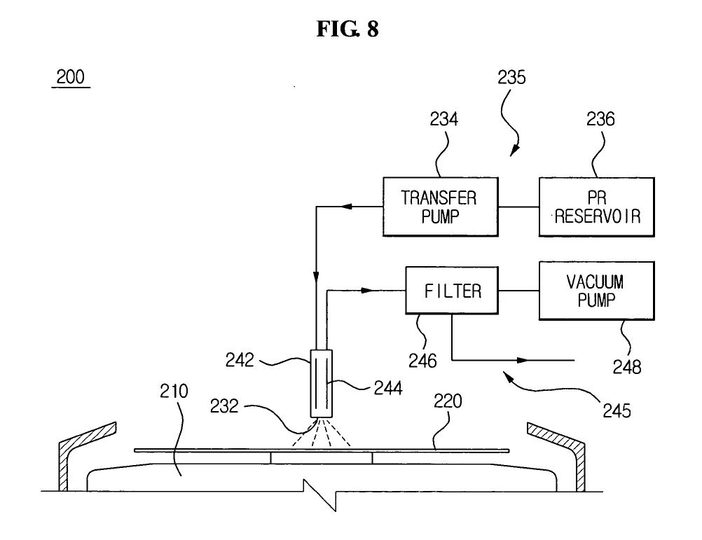

FIG. 8 is a configuration diagram illustrating a liquid coating apparatus according to an example embodiment.

Referring to FIG. 8, a liquid coating apparatus 200 may include a support 210 and a wafer 220. The support 210 may be arranged in the center of the liquid coating apparatus and may be configured to support the wafer 220 arranged on the support 210. The liquid coating apparatus 200 may also include a nozzle section 235 and a laminar flow forming section 245. A nozzle 232 of the nozzle section 235 may be arranged above the support 210 and may be configured to move relative to a top surface of the support 210 on which the wafer 220 is placed. The laminar flow forming section 245 may be used in combination the nozzle section 235 and a cover 242 may be around the nozzle 232 of the nozzle section 235 to form a forced air flow.

The nozzle 232 may move along a desired and/or predetermined route along, on or above the wafer 220, and the laminar flow forming section 245 may include a cover 242 provided around an external wall of the nozzle 232 to intake air. At least in part because the laminar flow forming section 245 intakes air and the nozzle 232 is able to move above the wafer while forming a laminar flow without a wake, a flow separation of air around the nozzle 232 may be reduced and/or prevented.

The nozzle section 235 may include the nozzle 232, a transfer pump 234, and a liquid photoresister reservoir 236. The nozzle section 235 may be for spraying a liquid photoresist necessary for a photoresist process. According to an example embodiment, the liquid photoresist may be supplied to the nozzle 232, and the nozzle 232 may be configured to spray the liquid photoresist on a surface of the wafer 220 while moving above the rotating wafer 220. Further, the transfer pump 234 may be arranged between the liquid photoresist reservoir 236 and the nozzle 232 and may be configured to supply the nozzle 232 with the liquid photoresist at a regular and/or desired pressure.

The nozzle 232 of the nozzle section 235 may move above the wafer 220 to spray a micro droplet and may be configured to move concurrently with a cover 242 of the laminar forming section 245.

The laminar flow forming section 245 may include the cover 242, one or more air holes 244, a filter 246 and a vacuum pump 248. The vacuum pump 248 may generate a suction force to form a comparatively low pressure between the nozzle 232 and the cover 242 to intake air from outside the cover 242 through the one or more air holes 244.

The air inhaled through the one or more air holes 244 may include a micro droplet and/or other materials. The filter 264 may be arranged within a route between the vacuum pump 248 and the cover 242 or nozzle 232 to filter out the micro droplet and/or the other materials.

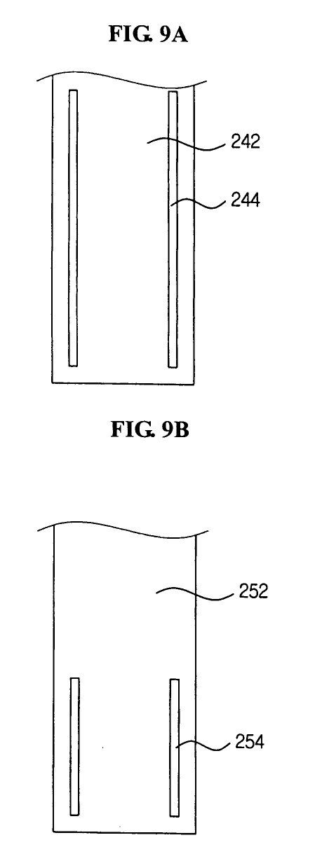

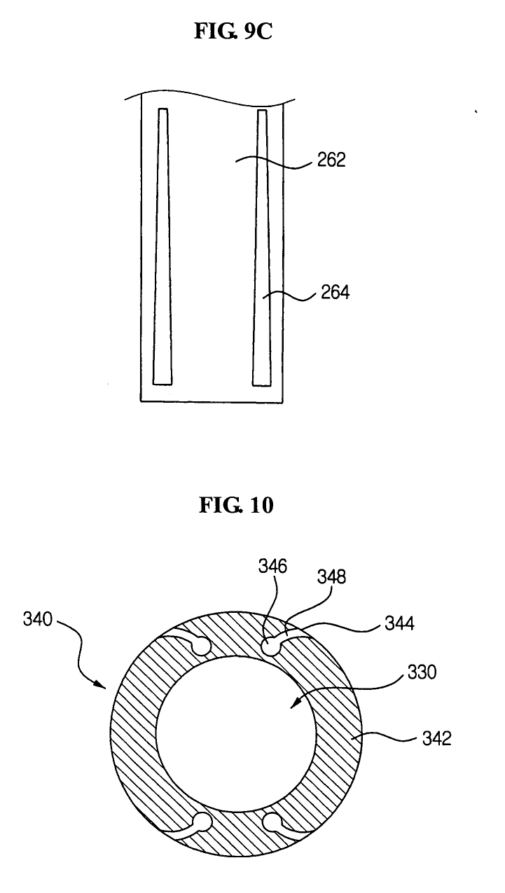

FIGS. 9A, 9B, and 9C are side views illustrating a laminar flow forming unit according to example embodiments.

The cover 242 including the air holes 244 shown in FIG. 9A may correspond to the cover 242 including the air holes 244 of the laminar flow forming section 245 illustrated in the FIG. 8. A nozzle 232 of a nozzle section 235 may be arranged within the cover 242 of FIG. 9A, may be supplied with a liquid photoresist or other liquids and may spray the liquid photoresist or other liquids in a micro droplet state out of the center of the nozzle 232. The cover 242 including the one or more air holes 244 may arranged around the nozzle 232. The cover 242 may cover the nozzle 232 and may be spaced apart from the nozzle 232 by a desired and/or predetermined distance to form a double-wall structure.

The one or more air holes 244 may be provided in the cover 242 and may be in the shape of a slit. For example, four air holes 244 may be symmetrically arranged around the nozzle 232. If a nozzle 232 arranged within the cover 242 is configured to move, the air holes 244 may be distributed within a range of an angle of about 45 degrees to about 135 degrees relative to the moving direction of the nozzle 232. More particularly, the air holes 244 may be distributed within a range of angles about 60 degrees to about 75 degrees and about 105 degrees to about 120 degrees relative to the moving direction of the nozzle 232.

According to an example embodiment, the support 210 may be configured rotate at a velocity of approximately 20˜30 rpm. In a conventional spin coating method and apparatus, a rotation support may be required to rotate at a velocity of approximately 1,000˜5,000 rpm to evenly spray a liquid. Because the support 210 according to an example embodiment may rotate in order to uniformly spray the liquid, the support 210 is not required to rotate as fast as in conventional spin coating apparatuses. Further, because the support 210 according to an example embodiment may rotate at a relatively low velocity, the sprayed liquid may be prevented from outwardly dispersing from the wafer 220 and thus, waste resulting from dispersed liquid may be reduced and/or minimized.

According to an example embodiment, if the laminar flow forming section 245 is operated, even if the nozzle 232 moves within a downflow, a wake may be reduced and/or prevented from occurring behind the nozzle 232. Accordingly, a laminar flow may be formed around the nozzle 232, and the suction occurring through the slit shape air holes 244 may reduce and/or prevent a flow separation from occurring from a surface of the nozzle 232. Even if a wake occurs, an area influenced by the wake may be reduced and/or minimized according to example embodiments.

Also, according to example embodiments, micro droplets sprayed from the nozzle 232 may be sprayed on a surface of the wafer 220 without ascending upward and/or spinning around and thus, the micro droplets generally do not contact and/or stick to a back surface of the nozzle 232. Accordingly, the micro droplets may be sprayed directly on the wafer 220. According to example embodiments, liquid is generally not formed on the nozzle 232 even if a plurality of the wafers 220 is repeatedly processed. Because the liquid is generally not formed on the nozzle 232, the nozzle 232 may remain relatively clean and the liquid coating operation may be executed for a relatively long period of time.

Referring to FIG. 9B, one or more air holes 254 may be provided in a lower portion of a cover 252. The one or more air holes 254 may not be provided over an entire length of a cover 252 and instead may be provided over a partial length of the nozzle 232 and/or the cover 252. In this case, a size of the one or more air holes 254 may not be regular. Further, as a location of the one or more air holes 254 becomes higher, the size of the air hole 254 may become smaller.

Referring to FIG. 9C, one or more air holes 264 may be provided along an entire length of the cover 262. In this case, a width of the one or more air holes 264 may not be regular. For example, the width of the one or more air holes may become smaller as a position in a lengthwise direction on the cover 262 changes. Conversely, according to an example embodiment, the width of the one or more air holes 264 may become larger as a position in a lengthwise direction on the cover 262 changes.

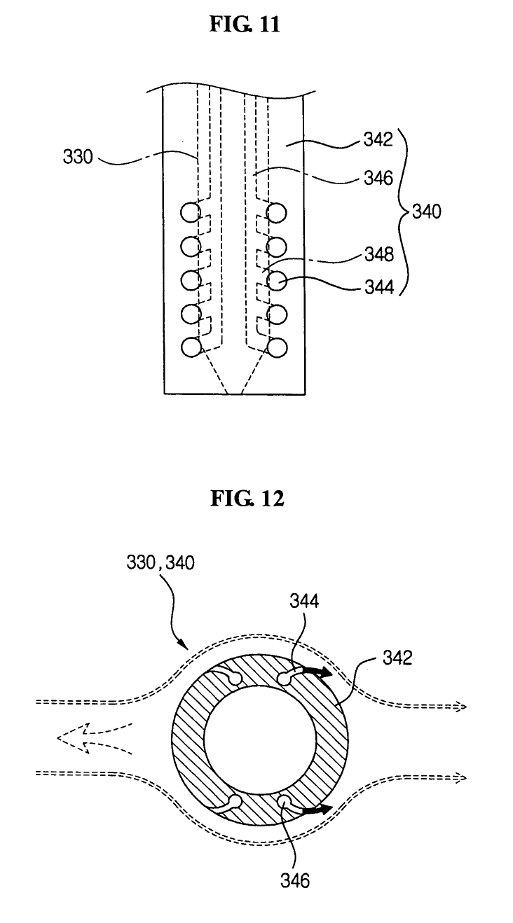

FIG. 10 is a cross-sectional view illustrating a nozzle unit and a laminar flow forming unit according to an example embodiment. FIG. 11 is a side view illustrating the nozzle unit 330 and the laminar flow forming unit 340 of FIG. 10. FIG. 12 is a cross-sectional view illustrating an example result of spraying according to an example embodiment.

Referring to FIGS. 10 through 12, a liquid coating apparatus may include a nozzle unit 330 and a laminar flow forming unit 340. A wafer may be arranged and/or placed on a support. The nozzle unit 330 and the laminar flow forming unit 340 may be used to spray a liquid, e.g. a liquid photoresist, while the nozzle unit 330 and laminar flow forming unit 340 move above the wafer.

The nozzle unit 330 may move along a desired and/or predetermined route above the wafer, and the laminar flow forming unit 340 may be provided on and/or arranged around an external wall of the nozzle unit 330. A forced air flow around the nozzle unit 330 may occur since the laminar flow forming unit 340 may blow air. Accordingly, a flow separation may be reduced and/or prevented from occurring.

A liquid photoresist may be supplied from the liquid photoresist reservoir to the nozzle unit 330 to be sprayed on a wafer. The transfer pump may be used in combination with the liquid photoresist reservoir to supply the nozzle unit 330 with the liquid photoresist at a regular and/or desired pressure.

The nozzle of the nozzle unit 330 may move above a wafer to aid the spraying of a micro droplet. The nozzle of the nozzle unit 330 may be configured to move together with a cover 342 of the laminar flow forming unit 340.

The laminar flow forming unit 340 may include the cover 342 and one or more air holes 344 may be provided in the cover 342. According to an example embodiment, the one or more air holes 344 may be angled and provided close to a tangential line of a surface of the cover 342 in order to force air blown from the one or more air holes 344 along the surface of the cover 342. The air blown from the one or more air holes 344 may generate a forced air flow to flow along the surface of the cover 342. Accordingly, a flow separation may be reduced and/or prevented from occurring around the cover 342.

Referring to FIGS. 10 and 12, the one or more air holes 344 may include a vertical passage 346 providing a vertical air passage close to an air hole 344 and a horizontal passage 348 providing a horizontal air passage from the vertical passage 346 to the air hole 344. The horizontal passage 348 may be slightly curved to smoothly guide air which may be blown from the one or more air holes 344.

According to an example embodiment, air may blow out through the air hole 344 provided behind the nozzle unit 330 and a wake may be reduced and/or prevented from occurring behind the nozzle unit 330.

According to other example embodiments, a cover may not necessarily be spaced apart from a nozzle; instead, a vertical passage, a horizontal passage and an air hole may be formed in the cover. Further, a center hole may be formed in the cover and may be utilized for a passage of the nozzle.

The air hole 344 may be formed in a circular shape or an oval shape according to an example embodiment. However, depending upon circumstances, the one or more air holes 344 may be formed in a slit shape and be designed to blow air.

A liquid coating apparatus of example embodiments may be utilized for spraying a liquid, e.g. a liquid photoresist, and other liquids on a target object.

A liquid coating apparatus of example embodiments may enable a spray coating to be stably accomplished by reducing and/or minimizing influence of an air flow by maintaining a laminar flow around a nozzle and decreasing the strength of a wake. Therefore, the uniformity of thickness of a liquid layer coated on a substrate may be increased and equipment contamination caused by dispersal of one or more liquid droplets may be reduced and/or prevented.

Although example embodiments have been shown and described in this specification and figures, it would be appreciated by those skilled in the art that changes may be made to the illustrated and/or described example embodiments without departing from their principles and spirit, the scope of which is defined by the claims and their equivalents.

What is claimed is:

1. A liquid coating apparatus of spraying a liquid on a target object, the apparatus comprising:
a nozzle unit spraying the liquid while moving above the target object; and
a laminar flow forming unit forming a forced air flow around the nozzle unit.

2. The apparatus of claim 1, further comprising:
a support supporting the target object,
wherein the support rotates the target object and the nozzle unit travels a route and sprays the liquid.

3. The apparatus of claim 1, wherein the forced air flow is a suction force to intake air around the nozzle unit.

4. The apparatus of claim 1, wherein forced air flow is a blowing force forcing the air around the nozzle unit along an external surface of the nozzle unit

5. The apparatus of claim 1, wherein the laminar flow forming unit comprises
a cover covering the nozzle unit and spaced apart from an external wall of the nozzle unit, and
at least one air hole formed in the cover.

6. The apparatus of claim 5, wherein the at least one air hole has at least one of a circular shape, an oval shape, and a slit shape.

7. The apparatus of claim 5, wherein the at least one air hole is a plurality of the air holes provided along the cover.

8. The apparatus of claim 7, wherein the plurality of air holes are distributed at an angle within a range of 45 to 135 degrees relative to a moving direction of the nozzle unit.

9. The apparatus of claim 7, wherein the plurality of air holes are distributed lengthwise on the nozzle unit.

10. The apparatus of claim 9, wherein the plurality of air holes increase in size or decrease in size along the nozzle unit in a lengthwise direction.

11. A liquid coating apparatus for spraying a liquid on a target object, the apparatus comprising:
a nozzle section including
a liquid supply source supplying the liquid, and
a supply pump pumping the liquid from the liquid supply source to the nozzle unit that sprays the liquid supplied from the supply pump; and
a laminar flow forming section including
the laminar flow forming unit of claim 1, that includes a cover arranged around the nozzle unit and has at least one air hole, and
a suction pump creating a lower pressure to intake external air between the cover and the nozzle unit,
wherein the suction pump inhales external air through the at least one air hole and inhibits a wake from occurring around the nozzle unit.

12. The apparatus of claim 11, wherein the at least one air hole is at least one of a circular shape, an oval shape and a slit shape.

13. The apparatus of claim 11, wherein the at least one air hole is a plurality of the air holes formed around the cover.

14. The apparatus of claim 11, wherein the at least one air hole is distributed at an angle within a range of 45 to 135 degrees relative to a moving direction of the nozzle unit.

15. A liquid coating apparatus for spraying a liquid on a target object, the apparatus comprising:
a nozzle section including
a liquid supply source supplying the liquid,
a supply pump pumping the liquid from the liquid supply source to the nozzle unit that sprays the liquid supplied from the supply pump; and
a laminar flow forming section including
the laminar flow forming unit of claim 1, that includes a cover arranged around the nozzle unit having at least one air hole, and
a blowing pump creating a higher pressure between the cover and the nozzle unit to blow air,
wherein the blowing pump blows air through the at least one air hole causing the blown air to flow along an external wall of the cover to inhibit a wake from occurring around the nozzle unit.

16. The apparatus of claim 15, wherein the at least one air hole is angled to direct air to move along an external wall of the cover.

17. The apparatus of claim 15, wherein the at least one air hole is at least one of a circular shape, an oval shape, and a slit shape.

18. The apparatus of claim 15, wherein the at least one air hole is a plurality of the air holes provided around the cover.

19. A liquid coating apparatus for spraying liquid photoresist on a wafer, the apparatus comprising:
a rotation support rotating and supporting the wafer;
a nozzle section including
a liquid photoresist reservoir supplying the liquid photoresist, and
a transferring pump transferring the liquid photoresist from the liquid photoresist reservoir to the nozzle unit; and
a laminar flow forming section including
the laminar flow forming unit of claim 1, that includes a cover having at least one air hole covering the nozzle unit to form a double-wall structure, and
a vacuum pump functionally connected between the cover and the nozzle unit to intake air,
wherein the at least one air hole is provided in lateral sides of the cover and arranged based on a moving direction of the nozzle unit and wherein the nozzle unit sprays the liquid photoresist while moving relative to the wafer on the rotation support.

20. The apparatus of claim 19, wherein the at least one air hole is at least one of a circular shape, an oval shape and a slit shape.

21. The apparatus of claim 19, wherein the at least one air hole is distributed at an angle within a range of 45 to 135 degrees relative to the moving direction of the nozzle unit.

22. The apparatus of claim 21, wherein the air hole is distributed at an angle within a range of 60 to 75 degrees relative to the moving direction of the nozzle unit.

23. A liquid coating apparatus for spraying liquid photoresist on a wafer, the apparatus comprising:
a rotation support supporting the wafer;
a nozzle section including
a liquid photoresist reservoir supplying the liquid photoresist, and
a supply pump pumping the liquid photoresist from the liquid photoresist reservoir to the nozzle unit; and
a laminar flow forming section including
the laminar flow forming unit of claim 1, that includes a cover having at least one air hole covering the nozzle unit to form a double-wall structure, and
a blowing pump functionally connected to a space between the cover and the nozzle unit to blow air,
wherein the at least one air hole is provided in lateral sides of the cover and arranged based on a moving direction of the nozzle unit so air blown through the at least one hole flows along an external wall of the cover and wherein the nozzle unit sprays the liquid photoresist while moving relative to the wafer on the rotation support.

24. A liquid coating method for spraying a liquid on a target object, the method comprising:
moving a nozzle unit relative to the target object;
spraying the liquid using the nozzle unit; and
forming a laminar flow around the nozzle unit with a forced air flow.

25. The method of claim 24, further comprising:
providing a downflow toward the target object on the target object.

26. The method of claim 24, wherein the moving of the nozzle unit relative to the target object includes rotating the target object, and moving the nozzle unit back and forth relative to the target object.

27. The method of claim 24, wherein the forming of the laminar flow includes inhaling air around the nozzle unit to generate the forced air flow.

28. The method of claim 24, wherein the forming of the laminar flow includes blowing air around the nozzle unit to generate the forced air flow.

29. The method of claim 28, wherein the forming of the laminar flow blows the air at an angle to cause the air to flow along an exterior of the nozzle unit.

30. The method of claim 24, further comprising:
providing at least one air hole in a cover around the nozzle unit,
wherein the at least one air hole is distributed within a range of an angle 45 to 135 degrees relative to a moving direction of the nozzle unit and the forming the laminar flow includes at least one of blowing air through the at least one air hole and inhaling air through the at least one air hole.

31. A laminar flow forming unit, comprising:
a cover configured to cover a nozzle unit and create a laminar flow around the nozzle unit; and
at least one air hole formed in the cover and configured to route a forced airflow used to provide the laminar flow.
